(19) United States
(12) Patent Application Publication
(10) Pub. No.: US 2022/0048605 A1
(43) Pub. Date: Feb. 17, 2022

(54) SYSTEM AND METHOD FOR RECHARGING POWER STORAGE DEVICES ON A WATERCRAFT

(71) Applicant: Edward Connell, Rancho Santa Margarita, CA (US)

(72) Inventor: Edward Connell, Rancho Santa Margarita, CA (US)

(21) Appl. No.: 17/513,164

(22) Filed: Oct. 28, 2021

Related U.S. Application Data
(63) Continuation-in-part of application No. 15/605,925, filed on May 25, 2017, now abandoned.
(60) Provisional application No. 62/346,112, filed on Jun. 6, 2016.

(51) Int. Cl. B63H 21/20; B63B 3/46; B60L 53/00

(52) U.S. Cl. CPC B63H 21/20; B60L 2200/32; B60L 53/00; B63B 3/46

(57) ABSTRACT

A system for recharging power storage devices on a watercraft is disclosed herein. The system for recharging power storage devices on a watercraft includes a shell, at least one linear channel fixedly mounted inside the shell, a turbine having at least one rotor, one shaft connected to the rotor, and a generator. The system for recharging power storage devices on a watercraft is useful for converting the rotational energy provided by the water flowing past the turbine rotor into electrical energy to charge a power storage device on a watercraft.

### CROSS-REFERENCE TO RELATED APPLICATIONS

The present application is a continuation-in-part of U.S. Non-Provisional patent application Ser. No. 15/605,925, filed on May 25, 2017, pending, which is related to and claims priority to U.S. Provisional Patent Application No. 62/346,112 filed Jun. 6, 2016, expired, both of which are incorporated by reference herein in their entirety.

### BACKGROUND OF THE INVENTION

The following includes information that may be useful in understanding the present disclosure. However, it is not an admission that any of the information provided herein is prior art nor material to the presently described or claimed inventions or that any publication or document that is expressly or implicitly referenced is prior art.

### FIELD OF THE INVENTION

The present invention generally relates to the field of ships and more specifically relates to fluid-current motors.

### DESCRIPTION OF RELATED ART

As the human population grows, more and more people are becoming acutely aware of the environmental impact on the world. But, unfortunately, vehicles powered by fossil fuels are a significant contributor to harmful emissions in our environment. For the last twenty years, motor vehicle manufacturers have produced various hybrid vehicles to combat internal combustion engine emissions. A hybrid vehicle uses multiple distinct types of power, such as an internal combustion engine and an electrical engine in combination.

While motor vehicles such as passenger cars have been quick to adopt the hybrid trend, many other motor vehicles are still behind the curve. One such motor vehicle is watercraft such as boats, ships, and yachts. Watercraft, in general, tend to consume much more fuel than motor vehicles for land. Furthermore, many watercraft used for commercial purposes such as fishing and shipping have been in service for many years and have outdated, less fuel-efficient engines. The cost of replacing the outdated technology in these watercraft is often hindered by purchasing an entirely new watercraft. A suitable solution is desired.

U.S. Pat. No. 6,508,191 to Raymond Spoljaric relates to an Aqua Turbo Generator. The described Aqua Turbo Generator includes an underwater generator for use with a surface vessel, having a cylindrical housing with two major parts: a turbine and a generator. The turbine is located in the front portion of the device and is connected to the generator in the rear of the device through a set of gears. A conical shaped filter pointed forward is located in the front of turbine to prevent clogging of the device. The size of the filter rib openings is smaller than the spacing between turbine blades so that any particulate matter that passes through the filter can freely pass through turbine and out the housing. At the junction between the conical filter and the main body of the housing, the water is deflected into the housing by a special deflector thus forcing the water to pass through turbine. A water flow passage is provided for a water outlet and a leak proof enclosure surrounds turbine, gears and generator. The housing is connected to the vessel by way of mounting frame.

### BRIEF SUMMARY OF THE INVENTION

Given the preceding disadvantages inherent in the known ships art, the present disclosure provides a novel system and method for recharging power storage devices on a watercraft. Therefore, the general purpose of the present disclosure, which will be described subsequently in greater detail, is to provide a system and method for recharging power storage devices on a watercraft.

A system and method for recharging power storage devices on a watercraft are disclosed herein. The system and method for recharging power storage devices on a watercraft include at least one channel on the watercraft, a turbine, and a generator.

According to another embodiment, a watercraft system and method for recharging power storage devices are also disclosed. The system and method for recharging power storage devices on a watercraft can include a shell configured to cover the watercraft's hull from bow to stern at least partially below the waterline in some examples.

The system also includes at least one linear channel, horizontally positioned and traversing the length of the shell. The system may further comprise a turbine positioned within the engine room of the watercraft and a generator positioned within the engine room of the watercraft. According to this embodiment, the shell comprises at least one fastener configured to attach the shell to the watercraft's hull firmly. The linear channel is tapered directionally toward the stern of the watercraft. The linear channel includes a first opening configured to allow water to enter the linear channel, a second opening configured to allow expulsion of water from the linear channel, and a chamber centrally located along the length of the linear channel. Chamber may comprise at least one opening to allow water to enter the chamber from the linear channel and at least one opening to exit the chamber into the linear channel.

According to this embodiment, the system provides a turbine with at least one rotor housed by a chamber of the linear channel. Rotor further comprises a shaft that extends from the center of the rotor, through the shell, through the watercraft's hull into a turbine. Finally, the turbine is further communicatively coupled to the generator.

In some exemplars, the system for recharging power storage devices on a watercraft, the system has at least one channel fixedly mounted inside or adjacent to the hull. A turbine couples to a first type shaft (turbine shaft) that extends into the channel. The turbine includes a rotor configured to rotate in response to the kinetic energy of water moving through the channel. Water flowing through the channel causes the rotor to rotate, which drives the turbine shaft. In some versions, the system includes a generator to convert the rotational motion of the turbine shaft into electric energy.

According to another embodiment, a method for recharging power storage devices on a watercraft is also disclosed herein. The method for recharging power storage devices on a watercraft may include the steps of installing a system for recharging power storage devices onto a watercraft, channeling water into a channel of the shell via forward movement of the watercraft, rotating a rotor positioned along the channel via passing water, generating kinetic energy via a rotational force of rotor caused by the passing water, converting potential energy into kinetic energy via a generator to produce electrical current, storing the electrical current to charge a power storage device, and channeling water outside the channel via at least one exit port.

For purposes of summarizing the invention, certain aspects, advantages, and novel features of the invention have been described herein. It is to be understood that not necessarily all such advantages may be achieved per any particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will better understand the following drawings and detailed description.

### BRIEF DESCRIPTION OF THE DRAWINGS

The figures which accompany the written portion of this specification illustrate embodiments and methods of use for the present disclosure, a system and method for recharging power storage devices on a watercraft, constructed and operative according to the teachings of the present disclosure.

FIG. 1 is a perspective view of the system and method for recharging power storage devices on watercraft during an ‘in-use condition showing water entering a channel.

FIG. 2 is a perspective view of the system and method for recharging power storage devices on the watercraft of FIG. 1, according to an embodiment of the present disclosure.

FIG. 3 is a top view of the system and method for recharging power storage devices on a watercraft of FIG. 1, according to an embodiment of the present disclosure.

FIG. 4 is a top perspective view of the system and method for recharging power storage devices on a watercraft of FIG. 1, according to an embodiment of the present disclosure.

FIG. 5 is a flow diagram illustrating a method of use for the system and method for recharging power storage devices on a watercraft, according to an embodiment of the present disclosure.

The various embodiments of the present invention will be described in conjunction with the appended drawings, wherein like designations denote like elements.

### DETAILED DESCRIPTION

As discussed above, embodiments of the present disclosure relate to a fluid-current motor and, more particularly, a system and method for recharging power storage devices on watercraft to improve the production of usable energy.

Generally, the present invention provides a system and method for recharging power storage devices on a watercraft. The present invention aims to provide a method to manufacture or attach a device to the hull of a watercraft below the waterline configured to funnel incoming water into a turbine to produce electricity. The funnel may advantageously decrease in size as it traverses the length of the watercraft, pressurizing the water before it is expelled into a chamber housing a rotor. The pressurized water imparts its energy on the rotor, rotating the blades of the rotor and rotating a shaft connected at one end to the rotor. At the opposite end of the shaft, there is a generator attached to convert the rotational energy of the turbine into electrical energy, which can then be stored in a power storage device and used by the electrical engine of the watercraft.

The system and method for recharging power storage devices on a watercraft may be configured to retrofit onto an existing watercraft to provide hybrid-electric power to a watercraft. The retrofit embodiment of the system may be removably or permanently fixable to the hull of a watercraft. The system may also be manufactured into the hulls of newly manufactured watercraft to provide an additional, optional power source for a watercraft. The size of the components of the present invention may vary based upon the size of the watercraft to which they are being applied.

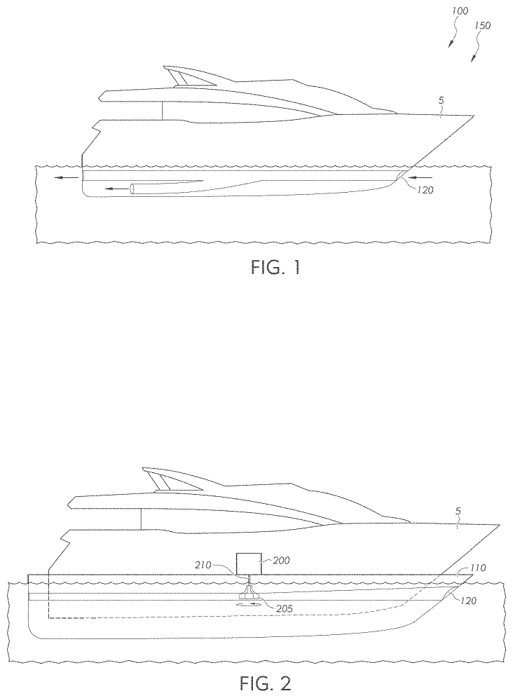

Referring now more specifically to the drawings by numerals of reference, there is shown in FIGS. 1-4, various views of a system 100 and method 500 for recharging power storage devices on a watercraft 5. FIG. 1 shows the system 100 for recharging power storage devices on a watercraft 5 during an ‘in-use condition 150, according to an embodiment of the present disclosure. Here, system 100 may produce usable energy on watercraft 5 when watercraft 5 is ‘in use’ traversing through the water.

As shown, the system 100 for recharging power storage devices on the watercraft 5 may mount on a hull of the watercraft 5. The invention may further comprise at least one linear channel 120 fixedly associated with the hull. The linear channel(s) 120 may be horizontally positioned and traverse the length of the hull. The linear channel(s) 120 is/are tapered directionally toward the stern of the watercraft 5. The linear channel(s) 120 may comprise a first opening configured to allow water to enter the linear channel 120 and a second to expel water from the linear channel 120.

According to one embodiment, the system 100 for recharging power storage devices on a watercraft 5 may be arranged as a kit 105. In particular, the system 100 for recharging power storage devices on a watercraft 5 may include a set of instructions 155. Instructions 155 may detail functional relationships about the structure of the system 100 and method 500 for recharging power storage devices on a watercraft 5 (such that the 100 and method 500 for recharging power storage devices on a watercraft 5 can be used, maintained, or the like, in a preferred manner). In addition, kit 105 may be used to retrofit system 100, having at least one linear channel 120, on a watercraft 5.

According to an embodiment of the present disclosure, FIG. 2 shows the system 100 for recharging power storage devices on a watercraft 5 of FIG. 1. As above, system 100 may include shell 110, including at least one linear channel 120 horizontally positioned and traversing the length of shell 110.

In referring to FIG. 2, linear channels 120 may further comprise a centrally located chamber 130. Chamber 130 may be positioned in abutment to the narrowest point of the linear channel 120 and includes at least one opening to allow water to enter chamber 130 from the linear channel 120. Further, the linear channel 120 may comprise at least one opening to allow water to exit chamber 130 into the linear channel 120. Chamber 130 encloses a rotor 205, which is attached to turbine shaft 210.

In continuing to refer to FIG. 2, the system 100 may further comprise a turbine 200. Turbine 200 comprises rotor 205 and turbine shaft 210. Turbine 200 is positioned such that water flowing through the linear channel 120 is directed toward rotor 205 at high pressure. Thus, the water imparts its energy on rotor 205, rotating it and, in turn, rotating attached turbine shaft 210.

In some exemplars, A revolving screw-like device, a screw, drives the watercraft. FIG. 2 also shows a screw 1210, which connects to propulsion means such as an engine or motor 1220 through a second type shaft 1230. Screw 1210 is responsible for propelling watercraft 5 through the water.

FIG. 3 is a top view of system 100 and method 500 for recharging power storage devices on a watercraft 5 of FIGS. 1-2, according to an embodiment of the present disclosure. As above, system 100 may include a tapered, linear channel 120, which directs water toward a turbine 200. Turbine 200 comprises rotor 205 and the shaft 210. The shaft 210 extends from the center of rotor 205, through the hull, through the hull of the watercraft 5 into turbine 200. Thus, the shaft 210 and rotor 205 configuration provides a means for turbine 200 to harness the energy of the water passing through the linear channel 120.

Preferably, turbine 200 further comprises a housing that contains the components of turbine 200 and may be located in or adjacent to the engine room 10 of a watercraft 5. This arrangement allows for efficient conversion of the rotational energy from turbine 200 into electrical energy. Turbine 200 may further include various gears to increase or decrease the rotation speed or reverse the rotational energy provided by rotor 205. Furthermore, turbine 200 may include gearing to transmit the rotational energy provided by rotor 205 to a different axis to suit the generator 300 to which the energy is being supplied.

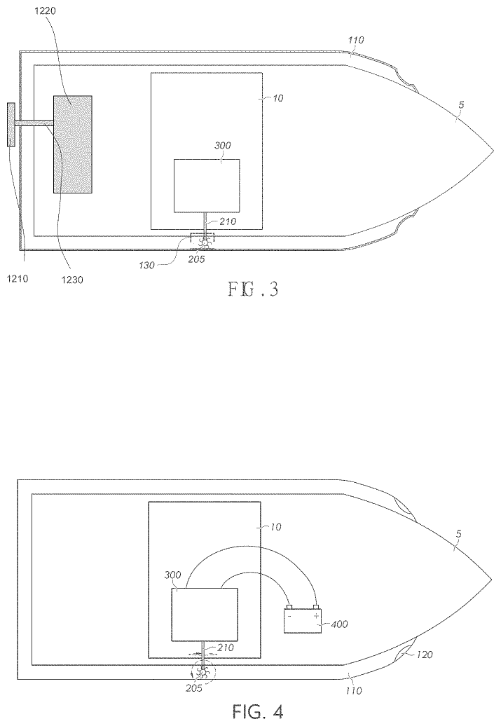

FIG. 4 is a top perspective view of system 100 and method 500 for recharging power storage devices on a watercraft 5 of FIGS. 1-3, according to an embodiment of the present disclosure. As above, system 100 may include turbine 200. Turbine 200 is communicatively coupled to a generator 300 configured to convert kinetic energy into electrical energy. The generator 300, located in or adjacent to the engine room 10 of a watercraft 5, may harness the rotational energy supplied by turbine 200 and convert it to electrical energy through electromagnetic induction.

The rotational energy provided by turbine 200 may move an electrical conductor such as a wire containing electric charges in a magnetic field to convert the energy into electricity. The electricity produced by the generator 300 may then be used to charge a power storage device 400 on a watercraft 5 for storage for later use. Furthermore, the electricity produced by the generator 300 may be used to directly power an electrical engine or other electrical systems in the watercraft 5.

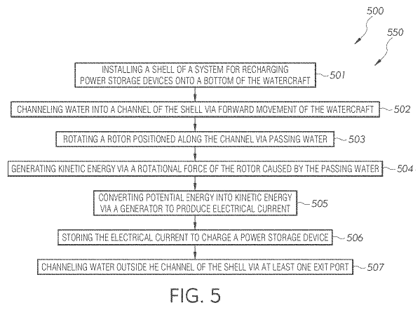

FIG. 5 is a flow diagram 550 illustrating a method of use 500 for recharging power storage devices 400 on a watercraft 5, according to an embodiment of the present disclosure. In particular, method 500 for recharging power storage devices on a watercraft 5 may include one or more components or features of the system 100 for recharging power storage devices on a watercraft 5 as described above. For example, as illustrated, the method of use 500 may include the steps of step one 501, installing a shell 110 onto the bottom of the watercraft 5; step two 502, channeling water into at least one linear channel 120 of the hull via forward movement of the watercraft 5; step three 503, rotating a rotor 205 positioned along the at least one linear channel 120 via passing water; step four 504, generating kinetic energy via a rotational force of rotor 205 caused by the passing water; step five 505, converting potential energy into kinetic energy via a generator 300 to produce electrical current; step six 506, storing the electrical current to charge a power storage device 400; and step seven 507, channeling water outside the at least one linear channel 120 of the hull via at least one exit port.

It should be noted that step six 506 is optional and may not be implemented in all cases. Optional steps of the method of use 500 are illustrated using dotted lines in FIG. 5 to distinguish them from the other methods of the method of use 500. It should also be noted that the steps described in the method of use can be carried out in many different orders according to user preference. The use of “step of” should not be interpreted as “step for” in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for recharging power storage devices on a watercraft (e.g., different step orders within the list mentioned above, elimination or addition of specific steps, including or excluding certain maintenance steps, etc.), are taught herein.

The embodiments of the invention described herein are exemplary. Numerous modifications, variations, and rearrangements can be readily envisioned to achieve substantially equivalent results, all of which are intended to be embraced within the spirit and scope of the invention. Further, the purpose of the abstract is to enable the U.S. Patent and Trademark Office and the public generally, and especially the scientist, engineers, and practitioners in the art who are not familiar with patent or legal terms or phraseology, to determine quickly from a cursory inspection the nature and essence of the technical disclosure of the application.

What is claimed is:

1. A system for recharging power storage devices on a watercraft, the system comprising:
at least one channel fixedly mounted inside or adjacent a watercraft hull;
a turbine coupled to a first type shaft extending into the channel, the turbine in communication with the at least one channel, the turbine including a rotor configured to rotate in response to kinetic energy from water moving through the channel;
and
a generator configured to convert the kinetic energy into electric energy.

2. The system of claim 1, wherein the at least one channel is horizontally positioned and traverses a length of a bow of the watercraft.

3. The system of claim 2, wherein the channel is linear and tapered directionally toward a stern of the watercraft.

4. The system of claim 3, wherein the channel comprises a first opening configured to allow water to enter the channel.

5. The system of claim 4, wherein the channel comprises a second opening configured to allow expulsion of water from the channel.

6. The system of claim 5, wherein the channel comprises a chamber that encloses the rotor.

7. The system of claim 6, wherein the chamber is positioned adjacent to a narrowest point of the channel.

8. The system of claim 7, wherein the turbine is positioned within an engine room of the watercraft.

9. The system of claim 8, wherein the generator is positioned within the engine room.

10. The system of claim 9, wherein the turbine powers the generator.

11. A system comprising:
a first channel associated with a first side of a watercraft hull;
a second channel associated with a second side of a watercraft hull;
a turbine coupled to a first type shaft extending into the first channel and coupled to the first type shaft extending into the second channel;
the turbine including a rotor coupled to the first type shaft; and
a generator connected to the one of more of the first type shafts and at least one power storage device.

12. The system of claim 11, wherein associated with a first side of a watercraft hull means positioned on an outside of the watercraft hull.

13. The system of claim 11, wherein associated with a first side of a watercraft hull means passing through the watercraft hull.

14. The system of claim 11, wherein the first channel and the second channel taper toward a stern of the watercraft.

15. The system of claim 14, wherein the first channel and the second channel each comprises at least one water intake opening near a front of the hull.

16. The system of claim 15, wherein the first channel and the second channel each comprises a water expulsion opening.

17. The system of claim 16, wherein a screw connected to a shaft other than a first type shaft propels the watercraft.

18. A method of generating power comprising:
installing a watercraft system having
a first channel associated with a side of a watercraft hull,
and
a turbine coupled to a first type shaft extending into the first channel and coupled to a first type shaft extending into the channel the turbine including a rotor coupled to the first type shaft;
propelling the watercraft using a screw connected to a shaft other than a first type shaft;
generating mechanical energy via a rotational force of the rotor caused by water passing through the first channel;
converting mechanical energy into electrical energy via a generator;
and
charging a power storage device with the electrical energy.
